(19) United States
(12) Patent Application Publication
(10) Pub. No.: US 2026/0166996 A1
(43) Pub. Date: Jun. 18, 2026

(54) SYSTEMS AND METHODS TO CREATE A VIRTUAL MEMO FROM CONNECTED VEHICLE DATA

(71) Applicant: TOYOTA MOTOR ENGINEERING & MANUFACTURING NORTH AMERICA, INC., PLANO, TX (US)

(72) Inventors: SEYHAN UCAR, Mountain View, CA (US); DIVYA SAI TOOPRAN, Mountain View, CA (US); EMRAH AKIN SISBOT, Mountain View, CA (US); KENTARO OGUCHI, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 18/982,301

(22) Filed: Dec. 16, 2024

(51) Int. Cl. B60K 35/23

(52) U.S. Cl. CPC B60K 35/23; B60K 2360/5915

(57) ABSTRACT

Systems and methods are provided for creating and transmitting virtual memos. The system can receive sensor data from a plurality of connected vehicles and determine one or more patterns in a geographic area based on the sensor data. The patterns can be associated with a driving condition in the geographic area. The system can generate a virtual memo describing the driving condition and transmit the virtual memo to the plurality of connected vehicles while the connected vehicles are located in the geographic area.

### CROSS-REFERENCE TO RELATED APPLICATIONS

The present application is related to co-pending and co-owned U.S. patent application Ser. No. ______, filed on even date herewith, titled “SYSTEMS AND METHODS TO CREATE A VIRTUAL MEMO FROM CONNECTED VEHICLE DATA,” which is incorporated herein by reference in its entirety.

### TECHNICAL FIELD

The present disclosure relates generally to the generation and display of virtual memos in vehicles, and in particular, some implementations may relate to the tailored creation, matching, and display of virtual memos based on contextual features, repetitive action, and correlated sensor data.

### DESCRIPTION OF RELATED ART

Virtual memos are virtual note that can enable virtual communication between users/drivers of a vehicle. Some virtual memos can be displayed using augmented reality (AR) overlays. Virtual memos can be generated to focus a driver's attention to specific environmental events and provide drivers with contextual data and instructions. Virtual memos also can facilitate communication and collaboration by allowing users to interact with virtual information in a shared physical space, such as an AR-enabled social platform. Traditional systems for creating virtual memos allow users to create and associate virtual notes with an entity and interact with the virtual memo by approaching the entity or viewing the entity on a map displayed by another device.

### BRIEF SUMMARY OF THE DISCLOSURE

According to various embodiments of the disclosed technology, a method can comprise receiving sensor data from a plurality of connected vehicles; determining one or more patterns in a geographic area based on the sensor data; associating the one or more patterns with a driving condition in the geographic area; generating a virtual memo describing the driving condition; and transmitting the virtual memo to the plurality of connected vehicles while the connected vehicles are located in the geographic area.

In some embodiments, the method further comprises displaying the virtual memo to drivers of the plurality of connected vehicles using an augmented reality overlay.

In some embodiments, the virtual memo is generated from a vehicle of the plurality of connected vehicles.

In some embodiments, the virtual memo is generated at a remote server connected to the plurality of connected vehicles.

In some embodiments, the method further comprises updating the virtual memo at a predetermined time interval based on receiving additional sensor data from the plurality of connected vehicles.

In some embodiments, the method further comprises adjusting timing for transmitting the virtual memo based on input from drivers of the plurality of connected vehicles.

In some embodiments, the method further comprises selecting portions of the sensor data to attribute to the driving condition.

In some embodiments, the method further comprises selecting portions of the sensor data to correlate with generated virtual memo.

According to various embodiments of the disclosed technology, a vehicle can comprise a processor and a memory coupled to the processor to store instructions. The instructions, when executed by the processor, can cause the processor to receive sensor data from a plurality of connected vehicles; determine one or more patterns in a geographic area based on the sensor data; associate the one or more patterns with a driving condition in the geographic area; generate a virtual memo describing the driving condition; and display the virtual memo to drivers of the plurality of connected vehicles using an augmented reality overlay.

In some embodiments, the processor is further configured to transmit the virtual memo to the plurality of connected vehicles while the connected vehicles are located in the geographic area.

In some embodiments, the processor is further configured to update the virtual memo at a predetermined time interval based on receiving additional sensor data from the plurality of connected vehicles.

In some embodiments, the processor is further configured to adjust timing for transmitting the virtual memo based on input from drivers of the plurality of connected vehicles.

In some embodiments, the processor is further configured to select portions of the sensor data to attribute to the driving condition.

In some embodiments, the processor is further configured to select portions of the sensor data to correlate with generated virtual memo.

According to various embodiments of the disclosed technology, a non-transitory machine-readable medium can have instructions stored therein, which when executed by a processor, causes the processor to receive sensor data from a plurality of connected vehicles; determine one or more patterns in a geographic area based on the sensor data; associate the one or more patterns with a driving condition in the geographic area; generate a virtual memo describing the driving condition; and update the virtual memo at a predetermined time interval based on receiving additional sensor data from the plurality of connected vehicles.

In some embodiments, the virtual memo is generated from a vehicle of the plurality of connected vehicles.

In some embodiments, the virtual memo is generated at a remote server connected to the plurality of connected vehicles.

In some embodiments, the processor is further configured to adjust timing for transmitting the virtual memo based on input from drivers of the plurality of connected vehicles.

In some embodiments, the processor is further configured to select portions of the sensor data to attribute to the driving condition.

In some embodiments, the processor is further configured to select portions of the sensor data to correlate with generated virtual memo.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for creating virtual memos in accordance with one embodiment of the systems and methods described herein.

FIG. 3A illustrates an example system for creating virtual memos in accordance with some embodiments.

FIG. 3B illustrates an example environment where virtual memos can be deployed, in accordance with one embodiment.

FIG. 4A illustrates an example method for creating virtual memos in accordance with one embodiment.

FIG. 4B illustrates an example method for viewing created virtual memos in accordance with one embodiment.

FIG. 5 is an example computing component that may be used to implement various features of embodiments described in the present disclosure.

The figures are not exhaustive and do not limit the present disclosure to the precise form disclosed.

### DETAILED DESCRIPTION

Virtual memos can be created in vehicle based on current or past vehicle sensor data. These virtual memos can incorporate a driver's action or reactions. For example, a driver can receive a memo to check the rear seat depending on the geographic location of the vehicle or vehicle event. Virtual memos can also be created from multiple connected vehicles. Multiple vehicles within a predefined range can form a peer-to-peer network (i.e., a vehicular micro cloud) to collaborate on sensor data collection. Virtual memos can also be created at a remote server. The remote server can collect information from multiple vehicles. As described above, traditional systems for creating virtual memos require user effort within the vehicle to create the virtual memo. Traditional systems for creating virtual memos can require users to create the virtual memos while the vehicle is in motion. If a user is not located in the passenger seat, it can be difficult for the driver to create a virtual memo while driving. In addition, if a passenger creates the virtual memo, the virtual memo may not have specific context related to the driver and vehicle's actions. Similarly, it can be difficult for users or drivers to view virtual memo while driving.

Embodiments of the systems and methods disclosed herein can create and display virtual memos without driver intervention. Sensor data from multiple connected vehicles can be gathered and analyzed for patterns. These patterns can be associated with one or more driving conditions. A virtual memo can be automatically generated and displayed to a vehicle driver. A remote server can receive multiple created virtual memos and infer contextual features for these memos. Virtual memos can be matched to vehicles based on connections between the contextual features and tags associated with the vehicle's driver profile. As a result, tailored virtual memos can be displayed to the driver. Virtual memos can be displayed in a preview format before a vehicle trip and in a live format at appropriate time intervals throughout the vehicle's trip.

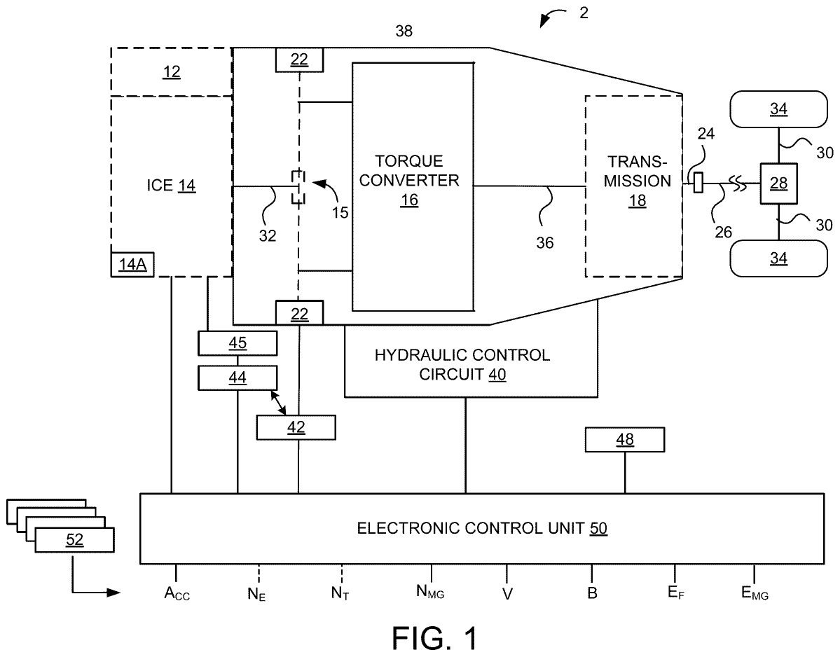

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for creating virtual memos can be implemented in other types of vehicle including gasoline-or diesel-powered vehicles, fuel-cell vehicles, electric vehicles, or other vehicles.

FIG. 1 illustrates a drive system of a vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 100 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 14 (engine RPM), a rotational speed, NMG, of the motor 22 (motor rotational speed), and vehicle speed, NV. These may also include torque converter 16 output, NT (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, EF, motor efficiency, EMG, hybrid (internal combustion engine 14+MG 12) efficiency, acceleration, ACC, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

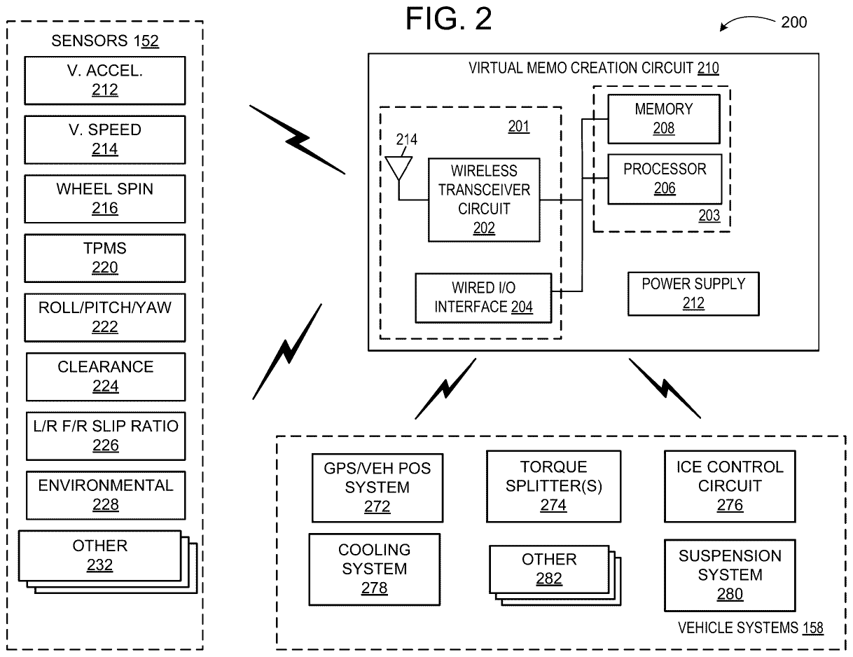

FIG. 2 illustrates an example architecture for virtual memo creation in accordance with one embodiment of the systems and methods described herein. Referring now to FIG. 2, in this example, virtual memo creation system 200 includes a virtual memo creation circuit 210, a plurality of sensors 152 and a plurality of vehicle systems 158. Sensors 152 and vehicle systems 158 can communicate with virtual memo creation circuit 210 via a wired or wireless communication interface. Although sensors 152 and vehicle systems 158 are depicted as communicating with virtual memo creation circuit 210, they can also communicate with each other as well as with other vehicle systems. Virtual memo creation circuit 210 can be implemented as an ECU or as part of an ECU such as, for example electronic control unit 50. In other embodiments, virtual memo creation circuit 210 can be implemented independently of the ECU.

Virtual memo creation circuit 210 in this example includes a communication circuit 201, a decision circuit 203 (including a processor 206 and memory 208 in this example) and a power supply 212. Components of virtual memo creation circuit 210 are illustrated as communicating with each other via a data bus, although other communication in interfaces can be included. Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208 can be made up of one or more modules of one or more different types of memory and may be configured to store data and other information as well as operational instructions that may be used by the processor 206 to virtual memo creation circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a virtual memo creation circuit 210.

Communication circuit 201 either or both a wireless transceiver circuit 202 with an associated antenna 205 and a wired I/O interface 204 with an associated hardwired data port (not illustrated). As this example illustrates, communications with virtual memo creation circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by virtual memo creation circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 210 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on a standard vehicle 10 with which the virtual memo creation system 200 is implemented. In the illustrated example, sensors 152 include vehicle acceleration sensors 212, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, and environmental sensors 228 (e.g., to detect salinity or other environmental conditions). Additional sensors 232 can also be included as may be appropriate for a given implementation of virtual memo creation system 200.

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 that can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, or an adjustable-damping suspension system; and other vehicle systems 282.

During operation, virtual memo creation circuit 210 can receive information from various vehicle sensors to determine when to create virtual memos. Communication circuit 201 can be used to transmit and receive information between virtual memo creation circuit 210 and sensors 152, and virtual memo creation circuit 210 and vehicle systems 158. Also, sensors 152 may communicate with vehicle systems 158 directly or indirectly (e.g., via communication circuit 201 or otherwise).

In various embodiments, communication circuit 201 can be configured to receive data and other information from sensors 152 that is used in determining whether to create a virtual memo. Additionally, communication circuit 201 can be used to send an activation signal or other activation information to various vehicle systems 158 as part of virtual memo creation. The decision regarding what action to take via these various vehicle systems 158 can be made based on the information detected by sensors 152. Examples of this are described in more detail below.

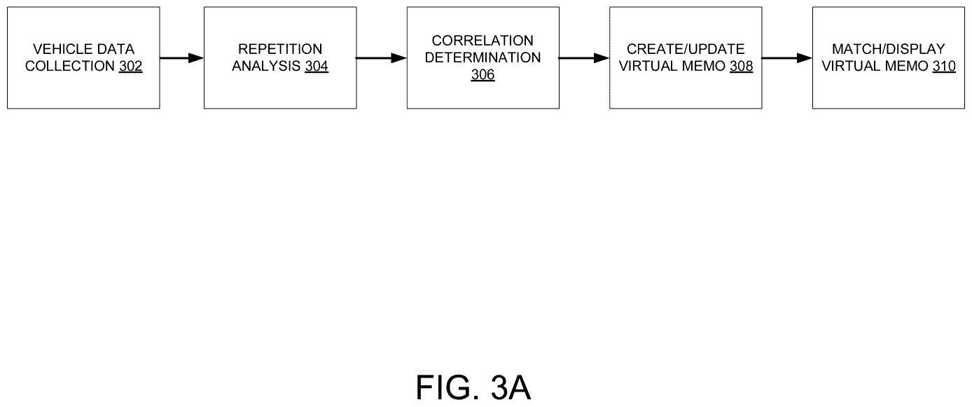

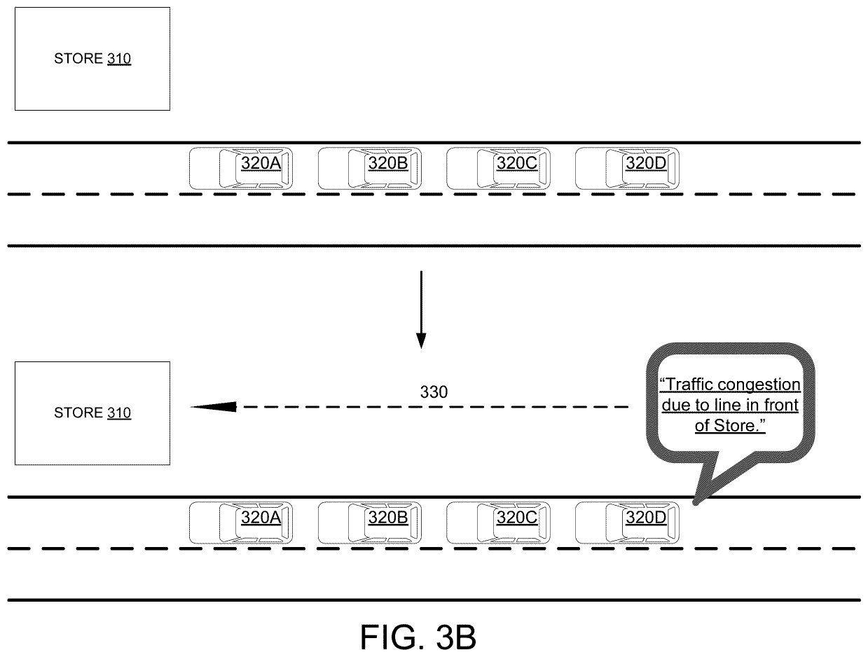

FIG. 3A illustrates an example system architecture for creating and displaying virtual memos. The system of FIG. 3A can be executed at a remote server, or in vehicle (e.g., via virtual memo creation circuit 210). The system can collect vehicle sensor data from one or more vehicles at block 302. Other included data can include location or GPS data, data on the vehicle type, or time-series data on detected events and driving actions. Driving events can be detected using multivariable time series analysis.

The system can collect this data at block 304 to perform a repetition analysis at block 304 to determine movement patterns. For example, recurring traffic jams that occur at the same time every weekday could be detected by analyzing lane-level capacity (e.g., by the presence of traffic jams near a particular location). As another example, non-recurring congestion caused by car crashes or work zones can be detected by camera-based situational understanding (e.g., by the presence of rubbernecking at a crash scene). As another example, confused drivers can be detected based on weaving behavior or other unsafe driving behavior. Patterns can be evaluated at the vehicle, section, locality, and/or city level to determine multiple layers of repeating or contrasting actions.

At block 306, the system can perform a correlation determination to associate the patterns with specific vehicle data. Some embodiments can incorporate a predefined list of events that can contain a predefined list of vehicle data to be checked to finalize a correlation. For example, to detect traffic congestion in a certain region, the system may specifically review the status of a vehicle's parking gear to determine that traffic is at a stop. Other embodiments can determine these correlations based on time ordered relationships. In such embodiments, the vehicle data can be ordered in a time series to infer correlations. As an example, a driving event can be caused by confused drivers at an intersection. Before these drivers become confused, they may exhibit multiple lane changes to position themselves in the correct lane. When the drivers are confused, they exhibit an unusual stop at the intersection. The system can detect this series of events to determine when and where the drivers became confused. Some embodiments may also incorporate machine learning to generate these correlations. Machine learning may be focused on unique visual features extracted from camera or video data from the vehicles. One or more machine learning models can process this camera or video data to determine an origin of a driving event and correlate it to driver behavior at that location.

At block 308, the system can create a new virtual memo based on the determined correlations. In some embodiments, the system may update an existing virtual memo based on new sensor data. Virtual memos can be generated with timing features specific to a vehicle driver. For example, some drivers may prefer earlier warning about driving events, whereas other drivers may want immediate or “on-time” notifications. As an example scenario, the system may infer that vehicles are experiencing traffic congestion at a geographic location due to activity at a nearby business. The correlation determination at block 306 can link the congestion to the rightmost lane of a road. The generated virtual memo may be specifically created and timed for vehicles located in that lane that are either slowing down or stopped.

At block 310, the system can match and display appropriate virtual memos to vehicles after generation. Vehicles can upload driver profiles to a remote server that define the driver's behavior during driving conditions or events. The driver profile can be dynamically updated based on sensor data or other driving event data. In some embodiments, the system can generate predictions on how the driver will react to a particular driving condition through predictive digital twin simulation. The driver profile may also be created using a multivariable time series analysis. In some embodiments, the driver profile may also be updated if the driver shows specific driving behavior at a particular location. The system can generate contextual tags for the driver. These tags can represent the contextual characteristics of the driver and the environment. Examples of contextual characteristics can include but are not limited to driver information (such as age, preferred route), driver type (conservative driving, impatient driving), vehicle info/type, location info, and/or communication capabilities. In some embodiments, the contextual features can be determined and generated using one or more machine learning models. A machine learning model can be trained to receive time-series data and correlate the data with features of a driving condition or event. In such embodiments, the machine learning model can generate both the driver profile and the contextual feature tags.

The system can accumulate generated virtual memos according to location, vehicle type and event. Once gathered, the virtual memos can be analyzed to generate the contextual features associated with the virtual memos. Example contextual features for virtual memos can include but are not limited to types of drivers who used the memo the most; associated repetitive action; movement patterns; location characteristics; and/or risk designation. The system can compare the contextual tags of the driver profiles with the contextual features of the virtual memos. Some embodiments can incorporate predefined thresholds to determine a “match” between the driver profile and a particular virtual memo. In some embodiments, if a tag match exceeds a certain threshold, the virtual memo can be displayed to the driver. The threshold can be a fixed value or a dynamic value that increases or decreases according to the current driving behavior of the driver or the features of the virtual memo. Dynamic thresholds can be impacted based on particular contextual features. As an example, in situations where the risk or safety level is dangerous, the threshold may be lowered.

After the virtual memo is matched to the driver's profile, the virtual memo can be appropriately displayed on a vehicle display. Some embodiments incorporate an AR overlay of the virtual memo on a display of the vehicle route. In cases where multiple virtual memos are displayed, some of these memos can be selected to be displayed in a preview mode before the trip. Memos can be selected based on safety features, impact to travel time, or other designated priorities. The virtual memos can also be displayed live during the vehicle trip. As described above, the virtual memos can be timed based on driver preferences obtained from the driver profile. In some embodiments, the system can select particular types of virtual memos to display as live. For example, a vehicle may display safety-related virtual memos live, while other virtual memos are displayed before the trip in preview mode in order to prevent overloading the driver with messages throughout a vehicle trip.

FIG. 3B illustrates an example scenario where a virtual memo can be created and displayed. As illustrated in FIG. 3B, vehicles 320A-D may be traversing a road that passes by store 310. Store 310 may be experiencing heavy customer activity (i.e., during a lunch rush), resulting in traffic congestion in the righthand lane as vehicles attempt to turn into store 310. The system can determine that the traffic congestion occurs during interval 330 as evidenced by sensor data showing that vehicles 320A-D begin slowing and stopping at a certain location on the road. As illustrated in FIG. 3B, the generated memo can be displayed at a location before interval 330 to alert drivers of the incoming traffic congestion. As described above, this display can be tailored to the driver profile to accommodate a driver's preferences on when to be notified of driving conditions.

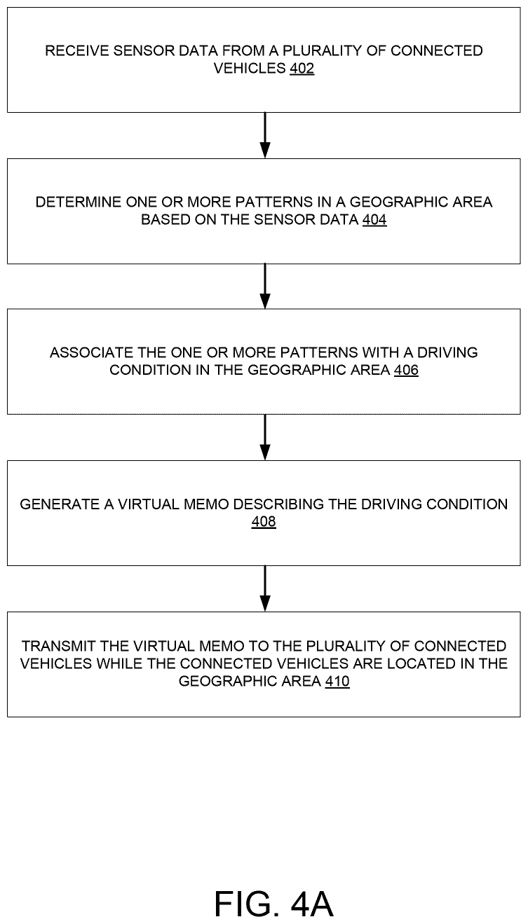

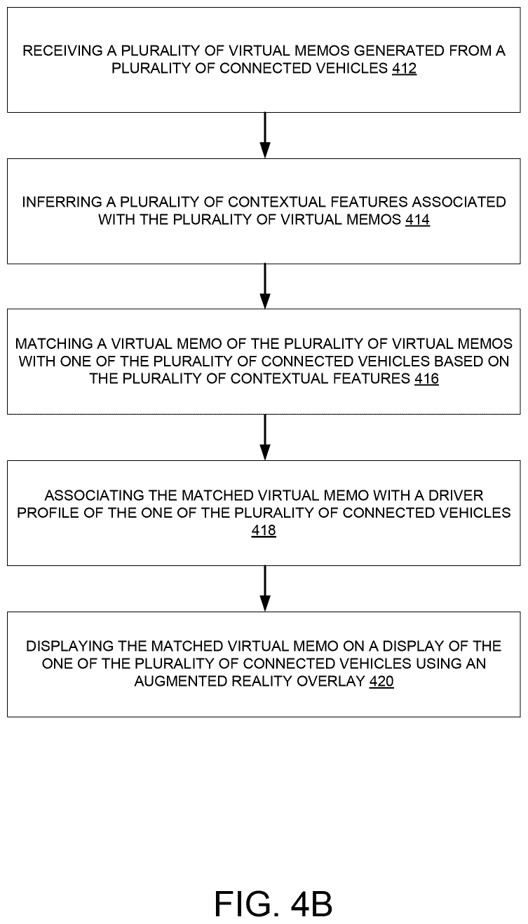

FIG. 4A illustrates an example method for creating virtual memos incorporating the architecture described above in FIG. 3A. At block 402, the system can receive sensor data from a plurality of connected vehicles. As described above, the system can receive vehicle sensor data, location or GPS data, data on the vehicle type, or time-series data on detected events and driving actions. At block 404, the system can determine one or more patterns in a geographic area based on the sensor data. As described above, patterns can be evaluated at the vehicle, section, locality, and/or city level to determine multiple layers of repeating or contrasting actions. At block 406, the system can associate the one or more patterns with a driving condition in the geographic area using correlation determinations. In some embodiments, the system can attribute specific sensor data to the driving condition. As described above, some embodiments can incorporate a predefined list of events that can contain a predefined list of vehicle data to be checked to finalize a correlation. Other embodiments can determine these correlations based on time ordered relationships. In embodiments incorporating time ordered relationships, the vehicle data can be ordered in a time series to infer correlations. Other embodiments may also incorporate machine learning models to generate these correlations. Machine learning may be focused on unique visual features extracted from camera or video data from the vehicles.

At block 408, the system can automatically generate a virtual memo describing the driving condition. The virtual memo can be generated in vehicle or at a remote server connected to the plurality of connected vehicles. In some embodiments, the system may update an existing virtual memo based on new sensor data. The virtual memo may be updated at a predetermined time interval based on new or additional sensor data received from the plurality of connected vehicles. The system can select portions of the sensor data to correlate with generated virtual memo and can update the virtual memo based on updates to the selected sensor data. As described above, virtual memos can be generated with timing features specific to a vehicle driver. In some embodiments, a vehicle driver can provide input to update the timing of how the virtual memo is displayed. At block 410, the system can transmit the virtual memo to the plurality of connected vehicles while the connected vehicles are located in the geographic area. In some embodiments, the virtual memo can be displayed to drivers in the connected vehicles using an AR overlay.

FIG. 4B illustrates an example method for viewing virtual memos incorporating the architecture described above in FIG. 3A. At block 412, the system can receive a plurality of virtual memos generated from a plurality of connected vehicles. At block 414, the system can infer a plurality of contextual features associated with the plurality of virtual memos. As described above, the system can accumulate generated virtual memos according to location, vehicle type and event. Example contextual features for virtual memos can include but are not limited to types of drivers who used the memo the most; associated repetitive action; movement patterns; location characteristics; and/or risk designation.

At block 416, the system can match a virtual memo of the plurality of virtual memos with one of the pluralities of connected vehicles based on the plurality of contextual features. As described above, the system can compare the contextual tags of driver profiles with the contextual features of the virtual memos. The contextual tags for driver profiles can include driver information (such as age, preferred route), driver type (conservative driving, impatient driving), vehicle info/type, location info, and/or communication capabilities. Some embodiments can incorporate predefined thresholds to determine a “match” between the driver profile and a particular virtual memo. In some embodiments, if a tag match exceeds a certain threshold, the virtual memo can be displayed to the driver. In some embodiments the threshold can be determined based on the driver profile or designated features of a generated virtual memo. At block 418, the system can associate the matched virtual memo with a driver profile of the one of the pluralities of connected vehicle.

At block 420, the system can display the matched virtual memo on a display of the one of the pluralities of connected vehicles using an augmented reality overlay. As described above, in cases where multiple virtual memos are displayed, some of these memos can be selected to be displayed in a preview mode before the trip. Memos can be selected based on safety features, impact to travel time, or other designated priorities. The virtual memos can also be displayed live during the vehicle trip.

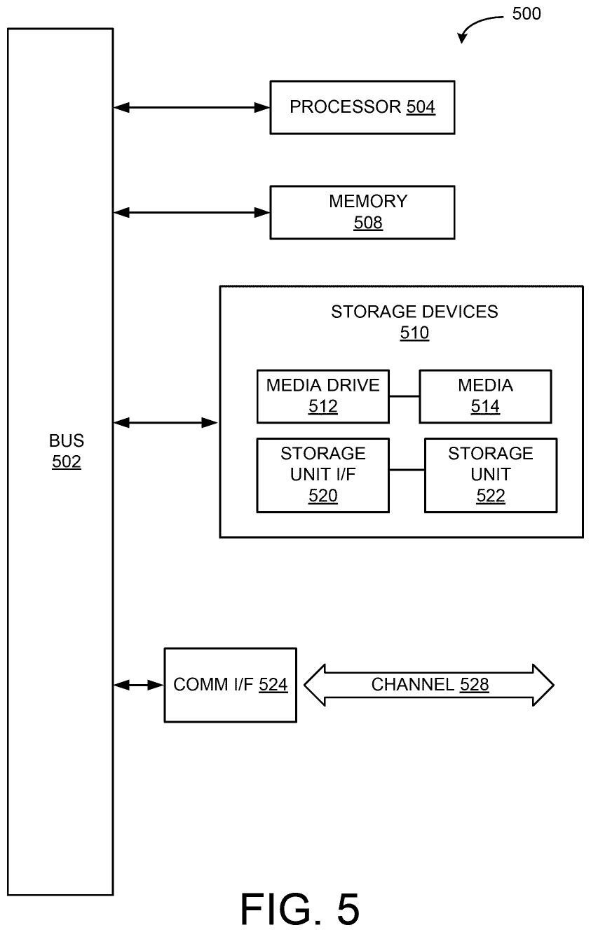

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
receiving sensor data from a plurality of connected vehicles;
determining one or more patterns in a geographic area based on the sensor data;
associating the one or more patterns with a driving condition in the geographic area;
generating a virtual memo describing the driving condition; and
transmitting the virtual memo to the plurality of connected vehicles while the connected vehicles are located in the geographic area.

2. The method of claim 1, further comprising displaying the virtual memo to drivers of the plurality of connected vehicles using an augmented reality overlay.

3. The method of claim 1, wherein the virtual memo is generated from a vehicle of the plurality of connected vehicles.

4. The method of claim 1, wherein the virtual memo is generated at a remote server connected to the plurality of connected vehicles.

5. The method of claim 1, further comprising updating the virtual memo at a predetermined time interval based on receiving additional sensor data from the plurality of connected vehicles.

6. The method of claim 1, further comprising adjusting timing for transmitting the virtual memo based on input from drivers of the plurality of connected vehicles.

7. The method of claim 1, further comprising selecting portions of the sensor data to attribute to the driving condition.

8. The method of claim 1, further comprising selecting portions of the sensor data to correlate with generated virtual memo.

9. A vehicle, comprising:
a processor; and
a memory coupled to the processor to store instructions, which when executed by the processor, cause the processor to:
receive sensor data from a plurality of connected vehicles;
determine one or more patterns in a geographic area based on the sensor data;
associate the one or more patterns with a driving condition in the geographic area;
generate a virtual memo describing the driving condition; and
display the virtual memo to drivers of the plurality of connected vehicles using an augmented reality overlay.

10. The vehicle of claim 9, wherein the processor is further configured to transmit the virtual memo to the plurality of connected vehicles while the connected vehicles are located in the geographic area.

11. The vehicle of claim 9, wherein the processor is further configured to update the virtual memo at a predetermined time interval based on receiving additional sensor data from the plurality of connected vehicles.

12. The vehicle of claim 9, wherein the processor is further configured to adjust timing for transmitting the virtual memo based on input from drivers of the plurality of connected vehicles.

13. The vehicle of claim 9, wherein the processor is further configured to select portions of the sensor data to attribute to the driving condition.

14. The vehicle of claim 9, wherein the processor is further configured to select portions of the sensor data to correlate with generated virtual memo.

15. A non-transitory machine-readable medium having instructions stored therein, which when executed by a processor, cause the processor to:
receive sensor data from a plurality of connected vehicles;
determine one or more patterns in a geographic area based on the sensor data;
associate the one or more patterns with a driving condition in the geographic area;
generate a virtual memo describing the driving condition; and
update the virtual memo at a predetermined time interval based on receiving additional sensor data from the plurality of connected vehicles.

16. The non-transitory machine-readable medium of claim 15, wherein the virtual memo is generated from a vehicle of the plurality of connected vehicles.

17. The non-transitory machine-readable medium of claim 15, wherein the virtual memo is generated at a remote server connected to the plurality of connected vehicles.

18. The non-transitory machine-readable medium of claim 15, wherein the processor is further configured to adjust timing for transmitting the virtual memo based on input from drivers of the plurality of connected vehicles.

19. The non-transitory machine-readable medium of claim 15, wherein the processor is further configured to select portions of the sensor data to attribute to the driving condition.

20. The non-transitory machine-readable medium of claim 15, wherein the processor is further configured to select portions of the sensor data to correlate with generated virtual memo.
